(19) United States
(12) Patent Application Publication
(10) Pub. No.: US 2026/0088910 A1
(43) Pub. Date: Mar. 26, 2026

(54) Systems and Methods for Quantumly Secure Channel Selection

(71) Applicant: The Trustees of Columbia University in the City of New York, New York, NY (US)

(72) Inventors: Dan RUBENSTEIN, New York, NY (US); Henry YUEN, New York, NY (US); James Lawrence BARTUSEK, New York, NY (US)

(73) Assignee: The Trustees of Columbia University in the City of New York, New York, NY (US)

(21) Appl. No.: 18/827,157

(22) Filed: Sep. 6, 2024

Related U.S. Application Data
(60) Provisional application No. 63/537,436, filed on Sep. 8, 2023.

(51) Int. Cl. H04B 10/70; G06N 10/40; H04L 9/08

(52) U.S. Cl. CPC H04B 10/70; G06N 10/40; H04L 9/0852

(57) ABSTRACT

Disclosed are implementations that include a method for secured communication including generating at a schedular, for a communication system with multiple communication channels, a series of multiple quantum bits (qubits), with each qubit encoding information representing a superposition of multiple states relating to channel assignments for one or more remote communication devices, and transmitting at least some qubits to at least some of the one or more remote communication devices. Measurement of the at least some qubits received at a first communication device results in collapse of the respective superposition of the multiple states encoded in each qubit into a respective one of the multiple states, with the collapsed states of the transmitted qubits measured at the first device representing an assignment to a distinct communication channel, from the multiple communication channels, through which the first device is configured to transmit and receive data.

### CROSS-REFERENCE TO RELATED APPLICATIONS

This application claims priority to, and the benefit of, U.S. Provisional Application No. 63/537,436, entitled “Systems and Methods for Quantumly Secure Channel Selection” and filed Sep. 8, 2023, the content of which is incorporated herein by reference in its entirety.

### BACKGROUND

Wireless device transmissions are naturally broadcast. When multiple devices wish to simultaneously use the available spectrum for their individual communication sessions, they have to “divide” the spectrum among the competing sessions, where this division can be implemented across various dimensions, i.e., frequency, time, or code. Abstractly, this division is referred to as a channel, where different sessions transmit on different channels so as to not interfere with one another. Many wireless technologies (e.g., cellular) can offer each session its own distinct channel to prevent interference. Other technologies, such as WiFi, assign access points to distinct channels to minimize cross-talk across independent parties' communications.

Adversarial jamming refers to an attack in which an adversary tries to jam the communications of a specific device. The adversary may have limited resources and so may be trying to evade detection by jamming as few channels as possible while still interrupting the communication of the target device. If the adversary has knowledge of the channel/device pairings, it could attack a session by broadcasting noise on the target device's channel. To protect against such adversaries, it is necessary to use methods of secure channel selection where devices get assigned channels in a way that is both (a) unpredictable, yet (b) avoids interference between the devices. A standard solution is to periodically “shuffle” the channel assignment of the devices such that their assignments change without mapping any pair of devices to the same channel. Without knowledge of the channel assignment strategy, an adversary can do little better than select a random set of channels to jam, in the hope that it can disrupt the communications the adversary seeks to jam. However, this shuffling strategy still has a security drawback in that if the adversary has insider information (e.g., if the adversary has infiltrated the scheduler which periodically chooses a new channel assignment, either randomly or pseudo-randomly), the adversary would still be able to jam the desired target device.

### SUMMARY

The present disclosure proposes a framework for secure channel selection (e.g., wireless channel selection) that provides security against adversarial jammers using principles of quantum physics. The proposed framework consider a scenario in which a jammer may have insider knowledge of channel assignments, or may have infiltrated the central base station that coordinates channel assignments. The framework implements protocols that defend against such adversarial jammers. In one example, the framework implements a procedure where a central base station distributes entangled qubits (or qudits) to the devices, which in turn use the qubits/qudits to generate private channel assignments. The security of the protocol is, in this example, relies on principles of quantum mechanics. Under the proposed framework, the central scheduler does not have knowledge of what channels have been assigned to various devices.

The proposed frameworks and approaches seek to innovate in the area of wireless communications by leveraging quantum technologies. Quantum computing technologies has enormous potential advantages for some computing tasks (scientific simulations, code-breaking, etc.). However there is also great promise to obtain “quantum advantage” in communication tasks, such as quantum cryptography or sensing. The proposed approaches have the potential to demonstrate quantum advantage in the realm of commercial (e.g., 4G, 5F), 6G (and beyond) wireless communications. The protocols used by the proposed framework rely on existing or near-term quantum technologies.

Accordingly, in some variations, a method for secured communication is provided that includes generating at a schedular, for a communication system with multiple communication channels, a series of multiple quantum bits (qubits), with each qubit of the series of multiple qubits encoding information representing a superposition of multiple states relating to channel assignments for one or more remote communication devices, and transmitting at least some qubits of the series of multiple qubits to at least some of the one or more remote communication devices. Measurement of the at least some qubits received at a first device of the one or more remote communication devices results in collapse of the respective superposition of the multiple states encoded in each qubit of transmitted at least some qubits into a respective one of the multiple states, with the collapsed states of the transmitted at least some qubits measured at the first device representing an assignment to a distinct communication channel, from the multiple communication channels, through which the first device is configured to transmit and receive data.

Embodiments of the method may include at least some of the features described in the present disclosure, including one or more of the following features.

Generating the series of multiple qubits can include generating the series of multiple qubits encoding entangled information representing the superposition of multiple states, with the entangled information allowing assignment of a second communication channel assignment, distinct from the first channel assignment, through which a second device of the one or more remote communication devices is configured to transmit and receive data.

Transmitting the at least some qubits may include sending extra qubits, classical bits, or a combination thereof, to select subsets of communication devices to implement exchange of distinct channels for devices in the select subsets of devices.

At least one other device from the one or more remote communication devices can be assigned the distinct communication channel to the first device to allow the first device and the at least one other device to communicate through the assigned distinct communication channel upon measurement of the entangled qubits by either one of the first device and the at least one other device.

The distinct communication channel can link the first device to a base station to allow the first device and the base station to communicate through the assigned distinct communication channel.

Generating the series of multiple qubits can include generating one or more groups of multiple qubits, and selecting from each group of multiple qubits a subset of qubits. A combination of selected subsets from the each group can include entangled quantum information about channel assignments for an associated at least one of the remote communication devices.

The method may further include transmitting to each of the at least some of the remote communication devices a corresponding one of combinations of qubits subsets selected from the each group of multiple qubits. A first combination of selected subsets transmitted to a first remote communication device associated with the first combination is different from a second combination of selected subsets transmitted to a second remote communication device associated with the second combination.

The method may further include shuffling, prior to transmitting, association between the at least some of the remote communication devices and corresponding different combinations of qubit subsets selected from the each group of multiple qubits.

Shuffling the association between the at least some of the remote communication devices and the different combinations of qubit subsets can include shuffling the association between a sub-group of at the at least some of the remote communication devices and the corresponding different combinations of qubit subsets for the sub-group.

Transmitting the at least some qubits can include transmitting the at least some qubits, encoded using photons, through an optical-type quantum channel.

The optical-type quantum channel may include one or more of an optical fiber and free space.

In some variations, another (second) method for secure communication is provided that includes generating at a schedular, for a communication system with multiple communication channels, a series of multiple high dimension quantum information units (qudits), with each qudit of the series of multiple qudits encoding information representing a superposition of multiple states relating to channel assignments for one or more remote communication devices, and transmitting at least some qudits of the series of multiple qudits to at least some of the one or more remote communication devices. Measurement of at least one qudit received at a first device of the one or more remote communication devices results in collapse of the respective superposition of the multiple states encoded in the at least one qudit into a respective one of the multiple states, with the collapsed states of the at least one qudit measured at the first device representing an assignment to a distinct communication channel, from the multiple communication channels, through which the first device is configured to transmit and receive data.

Embodiments of the second method may include at least some of the features described in the present disclosure, including one or more of the features described above in relation to the first method, as well as one or more of the following features.

Generating the series of multiple qudits may include generating a quantum data record for each of the one or more remote communication devices, wherein the quantum data record stores entangled quantum information proportional to a sum of channel assignment permutation states for the one or more communication devices.

Generating the series of multiple qudits can include preparing a superposition of states, with preparation of the superposition of the states by the scheduler with knowledge of an assigned channel measurement at the first device giving no information about measurement results at a second communication device, from the one or more remote communication devices, that is different from the first device or the scheduler.

In some variations, a further (third) method for secure communication is provided that includes receiving at a communication device, in a communication system with multiple communication channels and comprising one or more communication devices, at least a portion of a series of multiple quantum bits (qubits) generated at a remote scheduler node, with each qubit of the series of multiple qubits encoding information representing a superposition of multiple states relating to channel assignments for at least some of the one or more of the remote communication devices. The method additionally includes measuring at the communication device the received at least the portion of the series of qubits to cause a collapse of the respective superposition of the multiple states encoded in at least the portion of the series of qubit into a respective one of the multiple states, the collapsed states of the measured series of qubits representing a distinct communication channel assignment through which the communication device is configured to transmit and receive data.

Embodiments of the third method may include at least some of the features described in the present disclosure, including one or more of the features described above in relation to the first and second methods, as well as one or more of the following features.

The distinct communication channel can link the communication device to one or more of, for example, a base station to allow the first device and the base station to communicate through the assigned distinct communication channel, and/or at least one other device from the one or communication devices that is assigned the distinct communication channel assigned to the communication device to allow the communication device and the at least one other device to communicate through the assigned distinct communication channel upon measurement of the entangled qubits by the communication device.

Receiving the at least a portion of a series of multiple qubits may include receiving the at least the portion of the series of multiple qubits, encoded using photons, through an optical-type quantum channel.

In some variations, a secure communication system is provided that includes one or more remote communication devices configured to establish (classical) communication links using multiple communication channels available at the communication system, and a scheduler node configured to communicate with the one or more plurality of remote communication devices, the scheduler node comprising a processor-based device and quantum processing and communication circuitry. The scheduler is configured to generate a series of multiple quantum bits (qubits), with each qubit of the series of multiple qubits encoding information representing a superposition of multiple states relating to channel assignments for at least some of the one or more of the remote communication devices, and transmit at least some qubits of the series of multiple qubits to at least some of the one or more remote communication devices. Measurement of the at least some qubits at a first device of the one or more remote communication devices results in collapse of the respective superposition of the multiple states encoded in each qubit of the at least some qubits into a respective one of the multiple states, with the collapsed states of the transmitted at least some qubits measured at the first device representing an assignment to a distinct communication channel, from the multiple communication channels, through which the first device is configured to transmit and receive data.

Embodiments of the system may include one or more the features described in the present disclosure, including one or more of the features described above in relation to the first, second, and third methods.

Other features and advantages of the invention are apparent from the following description, and from the claims.

### BRIEF DESCRIPTION OF THE DRAWINGS

These and other aspects will now be described in detail with reference to the following drawings.

FIG. 1 is a schematic diagram of an example communication network in which nodes can transmit and/or receive quantum information to enhance channel security.

FIG. 2 is a flowchart of an example procedure for secure communication, generally performed at a central node (e.g., a scheduler) that communicates quantum information to enhance channel security.

FIG. 3 is a flowchart of another example procedure for secure communication, generally performed at a receiving communication device that uses quantum information to enhance channel security.

FIG. 4 is a flowchart of a further example procedure for secure communication, generally performed at a scheduler communication device that uses quantum information to enhance channel security.

Like reference symbols in the various drawings indicate like elements.

### DESCRIPTION

The proposed framework described herein implements a quantum solution for secure channel assignment. The proposed framework includes a central scheduler that distributes quantum entangled qubits to communication devices, allowing those devices to select channels in a non-colliding way. The scheduler, meanwhile, is oblivious to the channel assignment. This ensures that even if an adversary has infiltrated the scheduler, the channel assignment remains private.

An important principle on which the proposed framework is predicated is that quantum states generally yield random outcomes when measured. Furthermore, it is possible to design a protocol to detect if a quantum state has been illegally measured. Under the proposed framework, a quantum scheme is developed that can distribute non-colliding channel assignments to devices. The proposed framework is further enhanced under assumptions that a subset of sessions are conspiring with the scheduler to identify assignments of some (or all) of the remaining sessions or channels being used (in other words, it is assumed that some of the devices on the wireless network may be malicious). The proposed framework also includes an approach under which the communication devices can verify that the quantum states (which they use to obtain the channel assignment) have not been tampered with. The proposed framework has the potential to obtain “quantum advantage” in communication tasks (including quantum cryptography or sensing). The proposed framework can provide this quantum advantage in the realm of commercial (including 4G, 5G), 6G (and beyond) wireless communications.

As will be discussed in greater detail below, the proposed framework is generally configured to operate in two modes. In the first mode (referred to as Mode 1) there are k devices that wish to communicate with a base station. In this mode, each device is assigned a unique channel that the device can use to communicate with a base station (which listens/transmits on all channels). In a second mode (referred to as Mode 2) there are 2k devices that are paired up, such that each pair of devices is assigned to a unique (distinct) channel. In this version, there is no base station that the communication devices communicate with. For this implementation, the entangled qubits are also “paired up” such that each assignment is issued twice (so that both ends of the communication can receive the same channel).

The proposed approach applies naturally in an environment where there are 2k sessions (numbered 0 through 2^{k}−1) that must be mapped to channels also numbered 0 through 2^{k}−1. To illustrate the implementation and operation of the proposed framework, reference will be made to a running example with k=3 (8 sessions, 8 channels). To help understand the proposed approach, consider the classic analogue of the proposed quantum approach. Under the classical approach, a scheduler constructs a k-row by 2^{k}-column bit table (as shown below, in Table 1, for k=3):

TABLE 1

| | S₀ | S₁ | S₂ | S₃ | S₄ | S₅ | S₆ | S₇ |
|---|---|---|---|---|---|---|---|---|
| Group 0 | 0 | 0 | 0 | 0 | 1 | 1 | 1 | 1 |
| Group 1 | 0 | 0 | 1 | 1 | 0 | 0 | 1 | 1 |
| Group 2 | 0 | 1 | 0 | 1 | 0 | 1 | 0 | 1 |

The value b_{i,j} is defined as the value of the bit in the j^{th} column of the i^{th} row. Note that each column, read in the downward direction, can be viewed as an unsigned binary value: the value of the unsigned binary in the j^{th} column is one smaller than that of the j+1 column such that each column's value is distinct. The scheduler performs a unique assignment of a session Sᵢ by sending it the 3-bit sequence (in order) b_{0,j}, b_{1,j}, b_{j,2} from its corresponding j^{th} column. In this initial example, the j^{th} session would be assigned the unsigned binary value of j. The process is easily modified to assign random channels by shuffling the sessions to which columns are sent, e.g., the top row of the table above can be “shuffled,” to yield, in Table 2:

TABLE 2

| | S₃ | S₅ | S₀ | S₄ | S₁ | S₇ | S₆ | S₂ |
|---|---|---|---|---|---|---|---|---|
| Group 0 | 0 | 0 | 0 | 0 | 1 | 1 | 1 | 1 |
| Group 1 | 0 | 0 | 1 | 1 | 0 | 0 | 1 | 1 |
| Group 2 | 0 | 1 | 0 | 1 | 0 | 1 | 0 | 1 |

It is noted that if an adversary has access to the scheduler and can observe the result of the shuffle, it will know the assignment strategy.

The proposed framework relies on a quantum approach in which a scheduler generates k specially configured 2^{k}-qubit states of the following example form (shown for k=3):

$${G}_{0} = \frac{1}{\sqrt{2}} ( \vert 00001111 〉 + \vert 11110000 〉 )$$

$${G}_{1} = \frac{1}{\sqrt{2}} ( \vert 00110011 〉 + \vert 11001100 〉 )$$

$${G}_{2} = \frac{1}{\sqrt{2}} ( \vert 01010101 〉 + \vert 10101010 〉 ) .$$

The state G₀ is an 8-qubit state that is in an equal superposition of the classical states |00001111 [symbol] and |11110000 [symbol] . If the state is measured, then it “collapses” to the classical bitstring 00001111 with probability 1/2 and 11110000 with probability 1/2. Thus, the state G₀ is like a probabilistic mixture of two bitstrings, but importantly, it is possible (in principle) to verify whether the state G₀ has been measured by an adversary. Furthermore, these states are entangled: each qubit in the state G₀ is entangled with all other qubits in the state.

Once the scheduler has generated these 8-qubit states, it will distribute the j^{th} qubit of G0, G₁, G₂ to the j^{th} device (equivalently, the j^{th} session, at least in situations where a session uses only one channel). Each session then measures its received qubits, and takes the resulting measured sequence as its channel assignment (interpreted as a k=3-bit identifier). Note that each Gᵢ collapses entirely to one of two possible pure states; define Xᵢ=0 if Gᵢ collapses to the left pure state and Xᵢ=1 if Gᵢ collapses to the right pure state. For a device j, in which j is written as an unsigned binary b_{0,j}, b_{i,j}, b_{2,j}, it can be seen that this device will be assigned to channel b_{0,j}⊕X₀, b_{1,j}⊕X₁, b_{2,j}⊕X₂. This channel assignment has several desirable properties:
Each device is assigned a distinct channel.
The channel assigned to device j is distributed uniformly across possible assignments 0, . . . , 2^{k}−1.
The scheduler has no knowledge of the resulting assignment.

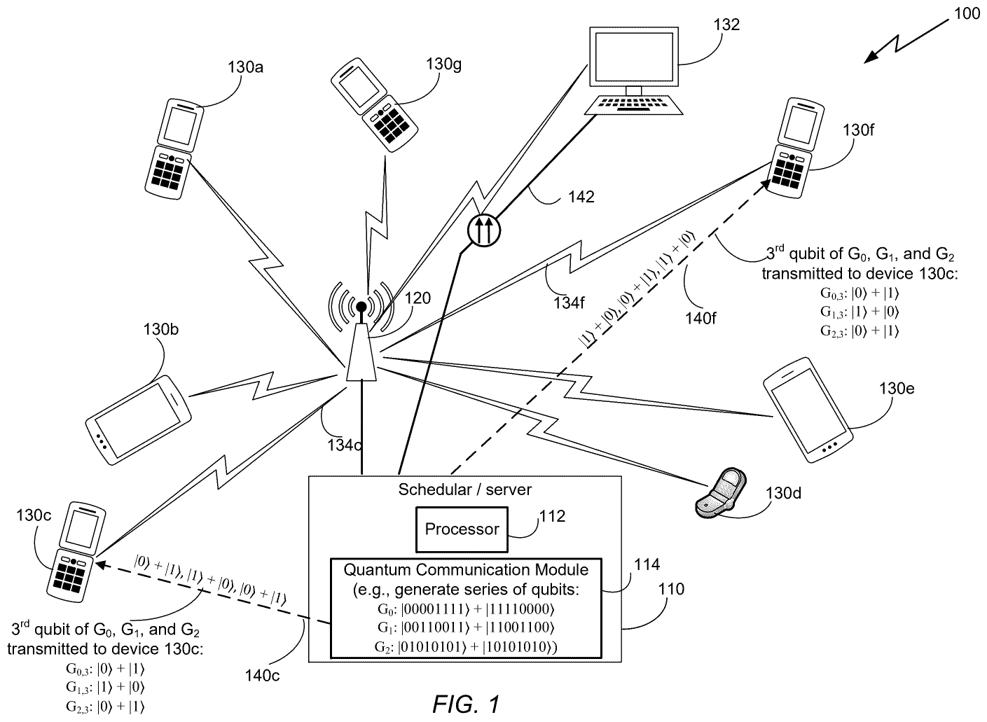

To illustrate operation of the proposed framework, consider the communication network 100 depicted in FIG. 1. For ease of illustration, and without limiting the implementations that can be realized for the proposed network, the network 100 includes eight (8) nodes which may include wireless nodes (such as wireless devices 130a-g) and/or computing devices (such as device 132) configured for wired communication (including communication via optical cables and electrically conducting cables) and/or wireless communication. Any number of nodes may be included with the network 100, which would require additional qubits to represent the number of channels/sessions that need to be established. It will be appreciated that wireless communication encompasses all types of wireless technologies and protocols, including wireless local access network (WLAN) technologies, which may be based on WiFi type implementations, wireless wide area networks (WWAN) technologies, which may be established using cellular links (e.g., according to 4G, 5G, 6G, and future generation technologies), short range wireless technologies (e.g., Bluetooth), etc.

As further illustrated in FIG. 1, communication of data (e.g., voice, packet-data, etc.) is performed using one or more wireless access points such as the wireless access point 120 depicted in FIG. 1. Upon determination and establishment of communication channels, using the quantum-based channel/session selection framework described herein, the various devices (nodes) in the network can communicate with one or more counterpart devices/nodes with which the channel/session was established. In the example of FIG. 1, the channels/sessions established for the various distributed devices of the network 100 link the various devices to the wireless access point 120, and in turn to a schedular/server 110 (which may use its processor 112 to process classical data and requests from the communication devices, and provide connectivity to other networks). In some embodiments, direct communication links between devices (also referred to as user equipment, or UE, devices) can be realized.

As noted, the communications network 100 the scheduler/server 110, which in turn includes a processor 112 and a quantum communication module 114 that is configured to transmit (either through transmission of particles carrying a superposition of quantum information, through quantum teleportation, or through any other technique to communicate quantum information) a series of multiple entangled qubits, with each qubit encoding information representing a superposition of multiple states from which unique channel assignments can be derived for a plurality of remote communication devices. The quantum communication module 114 of the unit 110 encodes quantum states, that represent superpositions of two or more states (the state definitions may be generated by the processor 112 and/or by the quantum communication module 114) as qubits, and transmits portions of the quantum states (e.g., polarized photons that upon receipt by a destination node are decoded into a measured state) through quantum channels (e.g., optical fibers or through the air) to respective destination devices/nodes. Entangling qubits can be performed in a variety of ways. For example, in some embodiments entanglement is performed through a spontaneous parametric down conversion (SPDC) in which a light source (such as a laser device) pumps out photon which are passed through non-linear crystals (e.g., one that has non-zero second order susceptibility) such as a beta-barium borate crystal a lithium niobate crystal, etc. Most of the photons pumped into the non-linear crystal pass through, but occasionally some of the photons undergo spontaneous down-conversion with polarization correlation, with the resultant correlated photon pairs having trajectories that are constrained along the sides of two cones whose axes are symmetrically arranged relative to the pump beam. Consequently, the polarization states of the two resultant photons that exit the non-linear crystal(s) are entangled. Other approaches for entangling qubits (whether as photon-based qubits, trapped ion qubits, superconducting qubits, etc.) can be used in various implementations of the proposed framework. It is noted that the quantum communication module 114, the processor 112 (the latter may be used to process data communicated to and from the various nodes, optionally via the wireless access point 120, or through wired communication channels such as optical channel 142) may all be part of a single integrated system, as depicted in FIG. 1, or may be distributed components that are electrically and/or optically, connected to each other.

With continued reference to FIG. 1, the scheduler 110 generates combinations of classical states that can be formed into quantum states, represented as a series of qubits, that are superposition of two or more classical states, and from which unique channel/sessions selections can be determined. In the example of FIG. 1, and as discussed above, the scheduler and/or the quantum communication model encode three (3) series of 8-qubits (namely G₀, G₁, and G₂, as illustrated in FIG. 1), with each qubit in G₀, G₁, and G₂ representing one bit in a three-bit channel identifier.

The quantum communication module transmits, via a quantum channel (optical fiber, such as optical fiber 142 which can be used to transmit quantum information and regular/classical data, or through some other medium through which photons can travel) the qubits in a particular position in the eight-qubit representations of each of G₀, G₁, and G₂. Thus, for example, the quantum communication module will transmit via quantum channel 140c (which implements an optical path for transmitting quantum-encoded information) the third qubit of each G₀, G₁, and G₂, to device 130c, which is designated as the third device of the communication network 100 (for the sake of clarity, only some of the quantum channels are depicted, although additional, or all, of the communication devices may be associated with a quantum channel). As noted above, transmission of quantum information may be performed through various quantum communication techniques, including transmission of actual particles carrying quantum information, quantum teleportation, etc.) On the other hand, the sixth device of the network 100, namely, the device 130f, will receive, in the embodiments of FIG. 1, the sixth qubit of each of G₀, G₁, and G₂, via the quantum channel 140f (which may also implement an optical path through an optical fiber or some other medium). Using the quantum states for G₀, G₁, and G₂ discussed above, the third device 130c therefore receives from the quantum communication module the quantum sequence of |0 [symbol] +|1 [symbol] , |1 [symbol] +|0 [symbol] , |0 [symbol] +|1 [symbol] (corresponding to the third qubit of each of G₀, G₁, and G₂), while device 130f receives a sequence of three qubits corresponding to the sixth qubit of each of G₀, G₁, and G₂, which, in the example of FIG. 1, is represented as |1 [symbol] +|0 [symbol] , |0 [symbol] +|1 [symbol] , |1 [symbol] +|0 [symbol] . Each of the other devices receives their respective three qubit sequences.

Assume, for example, that device 130c is the first device to either receive or measure the three qubit sequences that have been distributed to the various destination devices. Assume also that at measurement time the first qubit (|0 [symbol] +|1 [symbol] ) collapses to its first (left) quantum state, namely to the value 0, and that each of the last two qubits, when measured, collapse to their second (right) quantum states, namely to the values 0 (from the second qubit |1 [symbol] +|0 [symbol] ) and 1 (from the third qubit |0 [symbol] +|1 [symbol] . Accordingly, the decoded classical state measured by the third device 130c is ‘001’, which, with reference to Table 2, corresponds to the Ss channel/session. Because, as noted above, each qubit in each of G₀, G₁, and G₂ is entangled with all the other qubits of these 8-qubit groups, the collapse at the device 130c into the first, second, and second states, respectively, for the 3-qubit sequence it received from the quantum communication module 114, means that the unique three qubit sequences received at the other devices will have similarly collapsed to those same states. Thus, the qubit sequence |1 [symbol] +|0 [symbol] , |0 [symbol] +|1 [symbol] , |1 [symbol] +|0 [symbol] received by the sixth device will have collapses to the observed values of ‘110’ which corresponds to S₆ in Table 2. Accordingly, each destination device in the network 100 is assigned to a different channel without any of the other devices, or the unit 110 (or any other device elsewhere) knowing what channels/sessions other devices have been assigned.

Having assigned a channel to each of the devices illustrated in FIG. 1, actual classical data (voice data, actual digital or analog data, etc.) can be communicated using classical communication channels/sessions determined according to the proposed framework. Note that while the network devices illustrated in FIG. 1 include seven UE devices and one computing device (which can communicate data via wireless and wired communication links, such as through the fiber 142), any type of device may be included with the network 100. For example, some or all of the devices of the network 100 can be generally stationary computing terminals (servers, desktop, laptops, etc.) that can communicate data via wired (electrically conducting cables, optical cables) or wireless links. Such devices may also establish quantum channels with a quantum communication module, such as the module 114 depicted in FIG. 1, through which quantum information regarding channel/session selection for that device is transmitted (in accordance with the proposed framework described herein). In situations where a network node is connected to the unit 110 via an optical fiber (such as the fiber 142), the fiber can be used to transmit both classical data and the quantum information generated by the scheduler and/or the quantum communication module of the unit 110 (different optical signals may be used to transmit the quantum and classical data through the optical fiber; for example, different wavelengths may be used for the respective quantum and classical signals travelling through the optical fiber).

Two communication paradigms are envisioned when using the proposed framework implementing the present secured channel allocation scheme. Specifically:
Communication with a base-station. Here, each device, upon receiving its channel allocation, can contact a base station or access point. The base station listens on all channels and can identify the device by, for example, information in packet headers.
Communication between pairs of devices. This approach requires double the number of qubits, in which pairs of qubits must be identically arranged such that they can be delivered to both devices of the session. Note that this can easily be extended to cases where a session involves communication between an arbitrary number of k devices (all of which may, optionally, be assigned to the same channel).

While the scheduler itself, of the proposed framework, has no knowledge of the resulting allocation (regardless of the communication paradigm or scheme implemented), adversaries with knowledge of some sessions' assignments can still learn resulting assignments. For instance, in the scheme described above, session i=b_{0,j}, b_{1,j}, b_{2,j}, upon being assigned channel b_{0,j}⊕X₀, b_{i,j}⊕X₁, b_{2,j}⊕X₂ can determine the values of X₀, X₁, and X₂, and would be able to determine what channel other sessions' (or devices) are mapped to. In some embodiments, channel assignment information can be obscured by combining a shuffling approach in which the scheduler permutes the sessions such that for each j, a randomly chosen (without replacement) session/channel m is assigned to channel b_{0,j}⊕X₀, b_{1,j}⊕X₁, b_{2,j}⊕X₂. This protects against adversaries that only have knowledge of their own sessions' channel assignments, but does not necessarily defend against an adversary with knowledge of the scheduler's (classical) shuffling strategy.

The question then is whether there is a quantum mechanism that can obviate channel assignments versus adversaries with both session and scheduler access. The answer to this question is yes. A theoretical limit exists: when there are 2^{k} channels and an adversary is aware of some subset m of the session assignments, its likelihood of correctly “guessing” the correct assignment can be no less likely than (2^{k}−m)⁻¹. When an adversary has scheduler knowledge and even one session assignment, the adversary can correctly deduce the channel (i.e., likelihood of correctly guessing the channel assignment is 1).

One approach to reduce the likelihood of a correct guess is to apply a sub-shuffling procedure. In such a procedure, the scheduler can choose a subset of sessions and use collections of entangled qubits to have this subset “shuffle” their channels amongst themselves. While the scheduler may not know the current channel assignment because it does not know the outcomes of {Xᵢ}, it does know certain features about the assignments to the sessions. In particular, for any pair of sessions, it knows whether their i^{th} bit in their channel is the same or different, since this is only dependent on the relative values of b_{i,j} and b_{i,j′} for any pair of j, j′.

To further randomize the assignment, consider the following process. The scheduler builds a set S that is a subset of {0, . . . , k−1}. It can then partition sessions into disjoint classes {Cₘ}, where two sessions j and j′ are mapped to the same class Cₘ when b_{i,j}=b_{i,j′} for every i∈S. The scheduler can then choose a bit-sequence y₀, y₁, . . . yₖ₋₁ where yᵢ=0 when i∈S and otherwise is randomly set. If each session XORs their current channel assignment with this sequence, it remains within the same class Cₘ (its bits in positions indicated by S remain unchanged), and remains distinct from the resulting assignments of all other sessions within Cₘ. The final step is to determine this sequence y₀, . . . , yₖ₋₁ not by the scheduler selecting it, but instead encoding it as a GHZ entangled state. Only other sessions within the same class now know the channel assignment of a particular session. Thus, at a high level, the idea is that the scheduler sends out additional bits (or possibly even entangled qubits) to subsets of devices that they XOR with their original channel assignments to further obfuscate the channel assignments from other devices while still keeping assignments distinct.

Higher levels of obfuscation can be achieved by applying this shuffling approach with different sequences to different classes for a given S, and also repeating the process for different choices of S. Care must be applied iterating over different values for S. Note that after a shuffle, as the scheduler will no longer know the precise mapping of the b_{i,j} for sessions that have been sub-shuffled, and a subsequent arbitrary choice of S can result in colliding assignments. The rule that should be applied to two proposed classifications is that sub-shuffling may be performed over classification set S followed by a sub-shuffling over classification set T iff either S⊂T, T⊂S or T∩S=Ø. In some embodiments, sequence sub-shuffling classes S that maximally obscure channel assignment to sessions from the scheduler may be formed as a function of minimizing the numbers of qubits required to implement the sub-shuffling.

In some embodiments, communicating quantum information regarding channel assignments to the various nodes can be done as follows. A scheduler (e.g., the scheduler 110 of FIG. 1) prepares a uniform superposition over all channel assignment permutations. Upon transmission of the quantum data to the various devices, each communication device (client) measures their received quantum data record (or register), storing the received quantum data in a standard basis, thus collapsing the shared quantum state into a single random permutation. To illustrate, consider a scenario in which there are eight (8) devices/clients (similar to the scenario depicted in FIG. 1) to which distinct channels are to be assigned. In the first example embodiment discussed above to distribute the quantum information, the scheduler 110 prepared three (3) separate 8-qubit quantum states. Instead, in a second example embodiment to distribute quantum information to the various nodes of the network 100, the scheduler prepares a single entangled state proportional to:

$${\sum }_{σ ∈ {S}_{8}} \vert {σ}_{1} > ... \vert {σ}_{8} >$$

where the summing is performed over all permutations σ₁, σ₂, . . . , σ₈, and the state is on eight (8) quantum data records (registers), each of dimension 8. In this example embodiment, the i^{th} client (device) receives register i, which holds an 8-dimensional qudit, and measures in the standard basis to obtain some integer σᵢ. The result of these measurements is that the state collapses to σ₁, . . . , σ₈, for some uniformly random permutation σ of {1, 2, . . . , 8}. Intuitively, if the scheduler colludes with the i^{th} client/device, the scheduler and the i^{th} client just learn the value of σᵢ. From the scheduler's and the i^{th} device's perspective, the remainder of the system is in a mixture over all permutations of the remaining seven (7) elements. It is noted that under this proposed approach the quantum data used for channel selection is delivered in a single quantum transmission, rather than bit-by-bit.

To set up the quantum superposition the above second example embodiment, it is first noted that there is an efficiently computable bijection between all strings (i₁, . . . , iₙ)∈[n]×[n−1]×[1] and strings (j₁, . . . , jₙ)∈[n]× . . . [n] such that (j₁, . . . , jₙ) have no repeated entries (i.e., each (j₁, . . . , jₙ) defines a valid permutation of n elements). This bijection is referred to as f.

The next step is to prepare the state,

$$\vert {+}_{n} > … \vert {+}_{1} >= 1 / \sqrt{n !} {\sum }_{( {i}_{1} , ... , {i}_{n} ) ∈ [ n ] \times ... [ 1 ]} \vert {i}_{1} , … , {i}_{n} > ,$$

where, for each k:

$$\vert {+}_{k} >= 1 / \sqrt{k} {\sum }_{i = 1}^{k} \vert i >$$

is the uniform superposition over k elements.

Next, n new registers are registered, each of dimension n. f can then be computed in superposition, writing the output onto the new registers, namely:

$$1 / \sqrt{n !} {\sum }_{( {i}_{1} , ... , {i}_{n} )} \vert {i}_{1} , ... , {i}_{n} > ⊗ \vert {0}^{n} > -> 1 / \sqrt{n !} {\sum }_{( {i}_{1} , ... , {i}_{n} )} \vert {i}_{1} , ... , {i}_{n} > ⊗ \vert f ( {i}_{1} , ... , {i}_{n} ) > .$$

\hat{f}⁻¹ in superposition is then computed from the second register to the first register, resulting in the state,

$$\vert {0}^{n} > ⊗ 1 / \sqrt{n !} {\sum }_{( {i}_{1} , ... , {i}_{n} )} \vert f ( {i}_{1} , ... , {i}_{n} ) >= \vert {0}^{n} > ⊗ 1 / \sqrt{n !} {\sum }_{σ ∈ {S}_{n}} \vert σ > .$$

This second register holds the desired uniform superposition over all n-element permutations.

To set up a uniform superposition of M elements, an example procedure that could be performed is the following. Let k be the smallest integer such that M≤2^{k}, and first set up a uniform superposition over all k-bit strings by applying k Hadamard gates to all 0s state. Next, a fresh single-qubit register is initialized and the following function is computed,

$$f ( x ) = 0 if x \leq M ,$$

$$f ( x ) = 1 if x > M ,$$

in superposition, with the output written into the fresh register. Here, the input x is a binary string interpreted as an integer in [2^{k}]. Then, the output register is measured. If the result is 0, the remaining registers have collapsed to a uniform superposition of M elements. If the result is 1, the computations are thrown away and the example procedure starts over. Since the result is 0 with probability of at least 1/2, this procedure would generally not take long to complete.

The proposed framework allows an increase of the channel spectrum capacity. In embodiments in which the number of available channels is larger than the number of sessions, the wider space can be used to further obfuscate the specific channel assigned to a given session (and optionally assign multiple channels to one or more sessions). However, care must still be taken to ensure that different sessions are not assigned to the same channel. Consider a spectrum in which there are 2^{c} available channels with c>k. Since each session now requires a c-bit channel identifier, an easy extension is to assign each device to a specific channel by using the aforementioned scheme to assign a distinct series of the first k bits of the identifier, and then randomly select the last c-k bits (or use EPR pairs to randomly assign devices in the same session to the same suffix of c-k bits).

A shortcoming of this approach is the knowledge gained by an adversary for each session whose channel assignment it learns. Since the adversary knows that session's prefix, it can rule out all 2^{c-k} channels that contain that prefix being assigned to other sessions. Hence, if the adversary learns the channel assignments of m sessions, this leaves 2^{c}-m2^{c-k} remaining channels to which the remaining sessions might be assigned, as opposed to a minimum of 2^{c}−m in the case where channels are assigned to sessions via a sampling-without-replacement strategy over the 2^{c} available channels.

A potential vulnerability of the proposed framework relates to a scenario in which a scheduler generates quantum entangled states, but the adversary can potentially measure the states (e.g., G₀, G₁, G₂) before they are sent out to the devices, thus learning the channel assignment exactly. In this scenario, the devices would have no way of determining whether the states were already measured or not. To defend against this attack, an important principle in quantum information theory can be leveraged: it is possible (under some circumstances) to verify that a quantum state has not been illegally measured.

Consider a first verification approach in which such quantum state verification is used, namely Quantum Key Distribution (QKD). Under the QKD approach, two parties can exchange qubits over an insecure quantum channel, and communicate over an authenticated classical channel, in order to generate a perfectly secret shared key. Importantly, the security of the protocol does not rest on any unproven assumptions on the computational complexity of some mathematical problem, but rather relies on principles of quantum physics and isolation of the parties' devices from an adversary. A key insight that makes QKD possible is that the two parties can test whether the qubits sent over the channel—which is ultimately the source of randomness for the key generated at the end—has been measured by the adversary. Because, under the proposed frameworks, the states G₀, G₁, . . . G_{N} are the source of randomness used for the channel selection, if these states were measured before given to the devices, the channel assignment would no longer be private, thus alerting the devices (and their users) that the distributed qubits have been tampered with. Details about an example QKD approach, namely the BB84 approach, is provided in Bennett et al., “Quantum cryptography: Public key distribution and coin tossing” published In Proceedings of IEEE International Conference on Computers, Systems and Signal Processing, volume 175, page 8. New York, 1984, the content of which is herein incorporated by reference in its entirety.

Another verification approach is based on Bell inequalities and nonlocal games. These are experimental tests to determine whether two (or more) separated physical systems are quantum entangled with each other. Oftentimes these tests possess a strong property known as rigidity or self-testing: this is where they not only guarantee the presence of quantum entanglement, but in fact certify that the entanglement is of a specific form. Consequently, under this verification approach, the devices, after receiving qubits from the scheduler, run some kind of Bell test to verify that their qubits have not been tampered with. This approach would therefore provide assurances that the devices channel assignments are private. Further details about self-testing approach are provided in “Self-testing of quantum systems: a review” by Ivan Šupić et al., the content of which is herein incorporated by reference in its entirety.

In some embodiments, by combining ideas and techniques from QKD as well as Bell experiments, a lightweight verification mechanism can be implemented. Such a verification mechanism can make a channel assignment mechanism, such as the proposed framework described herein, robust to measurement or qubit tampering attacks (including attacks performed at the scheduler, or en route to sessions).

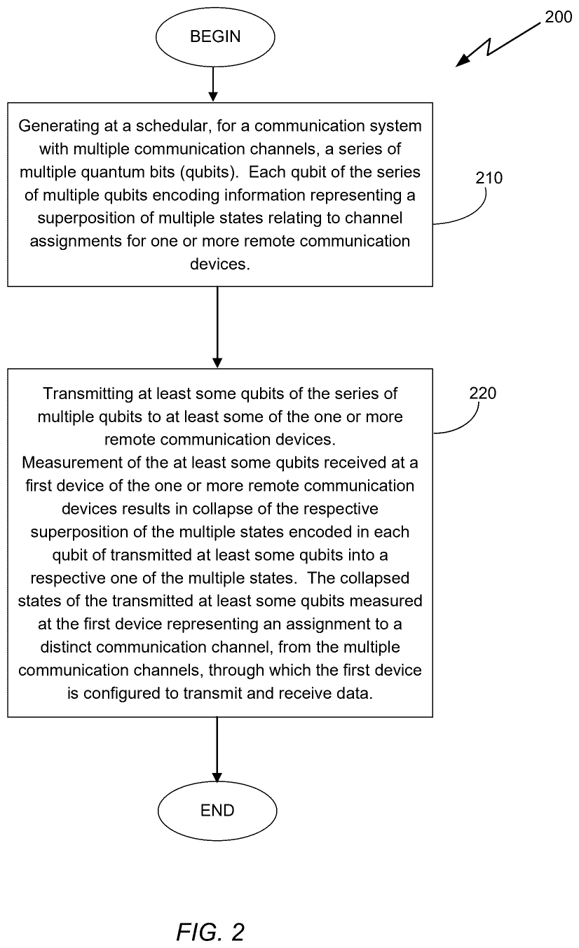

With reference next to FIG. 2, a flowchart of an example procedure 200 for secure communication, generally performed at a scheduler node that includes a quantum communication module (e.g., to generate qubits) and a processor-based device (to process classical data, including to perform computations involved in generating quantum information for the qubits) is shown. The procedure 200 includes generating 210 at a schedular, for a communication system with multiple communication channels, a series of multiple quantum bits (qubits). Each qubit of the series of multiple qubits encodes information representing a superposition of multiple states relating to channel assignments for one or more remote communication devices.

The procedure 200 further includes transmitting 220 at least some qubits of the series of multiple qubits to at least some of the one or more remote communication devices. Measurement of the at least some qubits received at a first device of the one or more remote communication devices results in collapse of the respective superposition of the multiple states encoded in each qubit of transmitted at least some qubits into a respective one of the multiple states, with the collapsed states of the transmitted at least some qubits measured at the first device representing an assignment to a distinct communication channel, from the multiple communication channels, through which the first device is configured to transmit and receive data (i.e., classical data).

In various examples, generating the series of multiple qubits may include generating the series of multiple qubits encoding entangled information representing the superposition of multiple states, with the entangled information allowing assignment of a second communication channel assignment, distinct from the first channel assignment, through which a second device of the one or more remote communication devices is configured to transmit and receive data. In some embodiments, transmitting the at least some qubits can include sending extra qubits, classical bits, or a combination thereof, to select subsets of communication devices to implement exchange of distinct channels for devices in the select subsets of devices.

In some examples, at least one other device from the one or more remote communication devices can be assigned the distinct communication channel to the first device to allow the first device and the at least one other device to communicate through the assigned distinct communication channel upon measurement of the entangled qubits by either one of the first device or the at least one other device. In various examples, the distinct communication channel links the first device to a base station to allow the first device and the base station to communicate through the assigned distinct communication channel.

In some embodiments, generating the series of multiple qubits can include generating one or more groups of multiple qubits, and selecting from each group of multiple qubits a subset of qubits. A combination of selected subsets from the each group can include entangled quantum information about channel assignments for an associated at least one of the remote communication devices. In such embodiments, the procedure 200 may further include transmitting to each of the at least some of the remote communication devices a corresponding one of combinations of qubits subsets selected from the each group of multiple qubits. A first combination of selected subsets transmitted to a first remote communication device associated with the first combination is generally different from a second combination of selected subsets transmitted to a second remote communication device associated with the second combination. Embodiments of the procedure 200 can further include shuffling, prior to transmitting, association between the at least some of the remote communication devices and corresponding different combinations of qubit subsets selected from the each group of multiple qubits. Such shuffling of the association between the at least some of the remote communication devices and the different combinations of qubit subsets may include shuffling the association between a sub-group of at the at least some of the remote communication devices and the corresponding different combinations of qubit subsets for the sub-group.

In some examples, transmitting the at least some qubits can include transmitting the at least some qubits, encoded using photons, through an optical-type quantum channel. The optical-type quantum channel may include one or more of, for example, an optical fiber and/or free space (e.g., air).

To help obfuscate channel assignment, in some examples the procedure 200 may further include determining by the scheduler node another sequence of bits, and transmitting the other sequence of bits to the plurality of remote communication devices. In such examples, at least some devices of the plurality of the remote communication devices may apply (e.g., using an XOR operation) the transmitted other sequence of bits to respective distinct channel assignments for the at least some devices that were determined based on the series of multiple qubits to derive a new set of distinct channel assignments for the at least some devices.

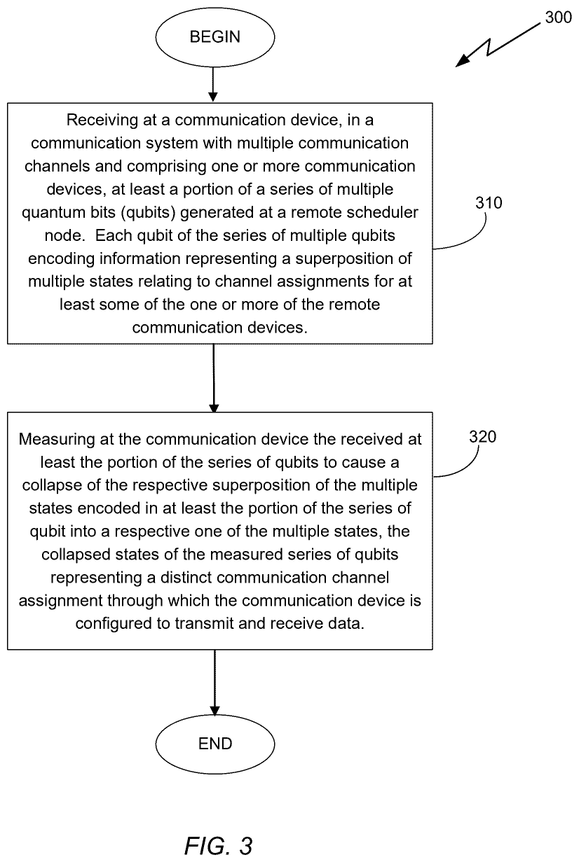

FIG. 3 is a flowchart of an example procedure 300 for secure communication that is generally performed at a destination device (wireless or wired device) to which the scheduler of procedure 200 transmitted quantum information. The procedure 300 includes receiving 310 at a communication device, in a communication system with multiple communication channels and comprising one or more communication devices, at least a portion of a series of multiple quantum bits (qubits) generated at a remote scheduler node, with each qubit of the series of multiple qubits encoding information representing a superposition of multiple states relating to channel assignments for at least some of the one or more of the remote communication devices. It is noted that the receiving device would generally be equipped with quantum information processing circuitry (e.g., to receive qubits and measure their quantum state), and classical processor circuitry (e.g., a processor-based unit to process and communicate classical data such as voice data, whether digital or analog, packet data, optical data, etc.).

The procedure 300 further includes measuring 320 at the communication device the received at least the portion of the series of qubits to cause a collapse of the respective superposition of the multiple states encoded in at least the portion of the series of qubit into a respective one of the multiple states. The collapsed states of the measured series of qubits represents a distinct communication channel assignment through which the communication device is configured to transmit and receive data.

In some examples, the distinct communication channel may link the communication device to one or more of, for example, a base station to allow the first device and the base station to communicate through the assigned distinct communication channel and/or at least one other device from the one or communication devices that is assigned the distinct communication channel assigned to the communication device to allow the communication device and the at least one other device to communicate through the assigned distinct communication channel upon measurement of the entangled qubits by the communication device.

In various examples, receiving the at least a portion of a series of multiple qubits can include receiving the at least the portion of the series of multiple qubits, encoded using photons, through an optical-type quantum channel (e.g., travelling through an optical fiber, through free space, or through some other medium).

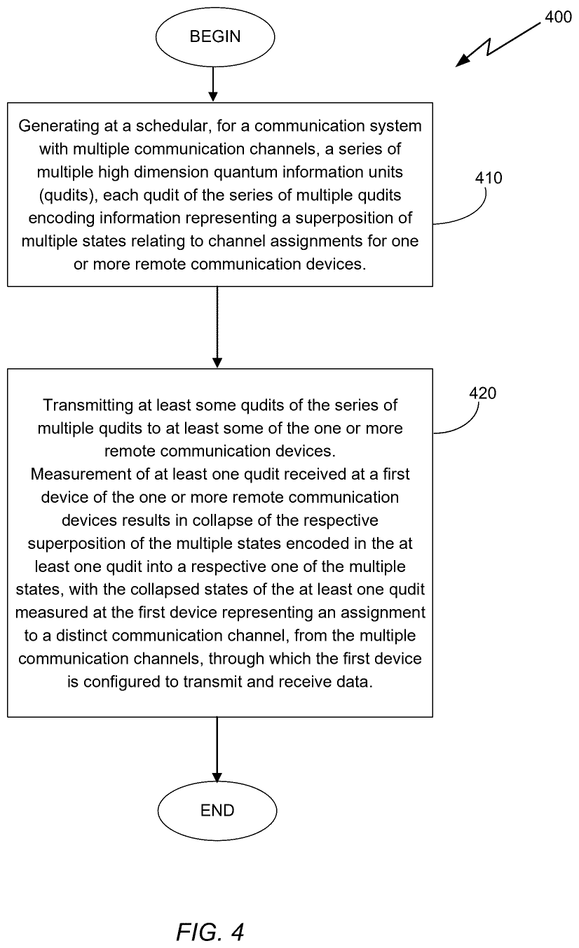

FIG. 4 is a flowchart of a further example procedure 400 for secure communication, generally performed at a scheduler communication device that uses quantum information to enhance channel security. The procedure 400 includes generating 410 at a schedular, for a communication system with multiple communication channels, a series of multiple high dimension quantum information units (qudits). Each qudit of the series of multiple qudits encoding information representing a superposition of multiple states relating to channel assignments for one or more remote communication devices. The procedure 400 additionally includes transmitting 420 at least some qudits of the series of multiple qudits to at least some of the one or more remote communication devices. Measurement of at least one qudit received at a first device of the one or more remote communication devices results in collapse of the respective superposition of the multiple states encoded in the at least one qudit into a respective one of the multiple states, with the collapsed states of the at least one qudit measured at the first device representing an assignment to a distinct communication channel, from the multiple communication channels, through which the first device is configured to transmit and receive data.

In various example embodiments, generating the series of multiple qudits can include generating a quantum data record for each of the one or more remote communication devices. The quantum data record stores entangled quantum information proportional to a sum of channel assignment permutation states for the one or more communication devices. In some embodiments, generating the series of multiple qudits may include preparing a superposition of states, with preparation of the superposition of the states by the scheduler with knowledge of an assigned channel measurement at the first device giving no information about measurement results at a second communication device, from the one or more remote communication devices, that is different from the first device or the scheduler.

In some examples, generating the series of multiple qubits may include generating a quantum data record for each of the one or more communication devices, wherein the quantum data record stores entangled quantum information proportional to a sum of channel assignment permutation states for the one or more communication devices. In some embodiments, generating the series of multiple qubits can include preparing a superposition of states, wherein preparation superposition of the states by the scheduler with knowledge of an assigned channel measurement at the first device gives no information about measurement results at a second communication device, from the one or more communication device, that is different from the first device or the scheduler.

Performing the various techniques and operations described herein may be facilitated, at least in part, by a controller device(s) (e.g., a processor-based computing device). Such a controller device may include a processor-based device such as a computing device, and so forth, that typically includes a central processor unit or a processing core. The device may also include one or more distinct learning machines (e.g., neural networks) that may be part of the CPU or processing core. The controller may further include quantum processing hardware to generate signals encoding a superposition of states, with such quantum processing hardware being used to implement the quantum information framework described herein.

In addition to the CPU and the quantum processing hardware, the system includes main memory, cache memory and bus interface circuits. The controller device may include a mass storage element, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, generation of signals (e.g., at a central node or a scheduler) encoding quantum information, and the subsequent measurement (at remote devices) of such generated signals to facilitate distinct channel assignment. Quantum computing technologies can currently support devices with up to hundreds of qubits that can be individually controlled and accessed over computing/communication networks (forming computing clouds). It is expected that quantum computers will reach the fault-tolerance threshold needed to enable large-scale quantum computations. There rapid developments and progress in the area of the quantum technologies includes the generation of multiqubit entangled states in different quantum computing platforms, such as superconducting qubits, ion traps, neutral atoms, etc. As noted, quantum technologies, such as quantum key distribution technologies, can be harnessed to implement the proposed framework. Distribution of quantum entangled states over optical fibers and free space has been robustly demonstrated, and can serve as a basis for a mechanism for the central scheduler to distribute entangled states to devices in the field. It is noted that there is no need for long-term storage of quantum states because the devices can immediately measure the qubits that it receives.

The storage device may include computer program products that when executed on the controller device (which, as noted, may be a processor-based device) causes the processor-based device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

In implementations that include learning machines, different types of learning architectures, configurations, and/or implementation approaches may be used. Examples of learning machines include neural networks, including convolutional neural network (CNN), feed-forward neural networks, recurrent neural networks (RNN), etc. Feed-forward networks include one or more layers of nodes (“neurons” or “learning elements”) with connections to one or more portions of the input data. In a feedforward network, the connectivity of the inputs and layers of nodes is such that input data and intermediate data propagate in a forward direction towards the network's output. There are typically no feedback loops or cycles in the configuration/structure of the feed-forward network. Convolutional layers allow a network to efficiently learn features by applying the same learned transformation(s) to subsections of the data. Other examples of learning engine approaches/architectures that may be used include generating an auto-encoder and using a dense layer of the network to correlate with probability for a future event through a support vector machine, constructing a regression or classification neural network model that indicates a specific output from data (based on training reflective of correlation between similar records and the output that is to be identified), etc.

The neural networks (and other network configurations and implementations for realizing the various procedures and operations described herein) can be implemented on any computing platform, including computing platforms that include one or more microprocessors, microcontrollers, and/or digital signal processors that provide processing functionality, as well as other computation and control functionality. The computing platform can include one or more CPU's, one or more graphics processing units (GPU's, such as NVIDIA GPU's, which can be programmed according to, for example, a CUDA C platform), and may also include special purpose logic circuitry, e.g., an FPGA (field programmable gate array), an ASIC (application-specific integrated circuit), a DSP processor, an accelerated processing unit (APU), an application processor, customized dedicated circuitry, etc., to implement, at least in part, the processes and functionality for the neural network, processes, and methods described herein. Generally speaking, a computer accessible storage medium may include any non-transitory storage media accessible by a computer during use to provide instructions and/or data to the computer. For example, a computer accessible storage medium may include storage media such as magnetic or optical disks and semiconductor (solid-state) memories, DRAM, SRAM, etc.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus, and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method for secure communication, the method comprising:
generating at a schedular, for a communication system with multiple communication channels, a series of multiple quantum bits (qubits), each qubit of the series of multiple qubits encoding information representing a superposition of multiple states relating to channel assignments for one or more remote communication devices; and
transmitting at least some qubits of the series of multiple qubits to at least some of the one or more remote communication devices;
wherein measurement of the at least some qubits received at a first device of the one or more remote communication devices results in collapse of the respective superposition of the multiple states encoded in each qubit of transmitted at least some qubits into a respective one of the multiple states, with the collapsed states of the transmitted at least some qubits measured at the first device representing an assignment to a distinct communication channel, from the multiple communication channels, through which the first device is configured to transmit and receive data.

2. The method of claim 1, wherein generating the series of multiple qubits comprises:
generating the series of multiple qubits encoding entangled information representing the superposition of multiple states, with the entangled information allowing assignment of a second communication channel assignment, distinct from the first channel assignment, through which a second device of the one or more remote communication devices is configured to transmit and receive data.

3. The method of claim 1, wherein transmitting the at least some qubits comprises:
sending extra qubits, classical bits, or a combination thereof, to select subsets of communication devices to implement exchange of distinct channels for devices in the select subsets of devices.

4. The method of claim 1, wherein at least one other device from the one or more remote communication devices is assigned the distinct communication channel to the first device to allow the first device and the at least one other device to communicate through the assigned distinct communication channel upon measurement of the entangled qubits by either one of the first device and the at least one other device.

5. The method of claim 1, wherein the distinct communication channel links the first device to a base station to allow the first device and the base station to communicate through the assigned distinct communication channel.

6. The method of claim 1, wherein generating the series of multiple qubits comprises:
generating one or more groups of multiple qubits; and
selecting from each group of multiple qubits a subset of qubits, wherein a combination of selected subsets from the each group includes entangled quantum information about channel assignments for an associated at least one of the remote communication devices.

7. The method of claim 6, further comprising:
transmitting to each of the at least some of the remote communication devices a corresponding one of combinations of qubits subsets selected from the each group of multiple qubits;
wherein a first combination of selected subsets transmitted to a first remote communication device associated with the first combination is different from a second combination of selected subsets transmitted to a second remote communication device associated with the second combination.

8. The method of claim 7, further comprising:
shuffling, prior to transmitting, association between the at least some of the remote communication devices and corresponding different combinations of qubit subsets selected from the each group of multiple qubits.

9. The method of claim 8, wherein shuffling the association between the at least some of the remote communication devices and the different combinations of qubit subsets comprises:
shuffling the association between a sub-group of at the at least some of the remote communication devices and the corresponding different combinations of qubit subsets for the sub-group.

10. The method of claim 1, wherein transmitting the at least some qubits comprises:
transmitting the at least some qubits, encoded using photons, through an optical-type quantum channel.

11. The method of claim 10, wherein the optical-type quantum channel comprises one or more of an optical fiber and free space.

12. A method for secure communication, the method comprising:
generating at a schedular, for a communication system with multiple communication channels, a series of multiple high dimension quantum information units (qudits), each qudit of the series of multiple qudits encoding information representing a superposition of multiple states relating to channel assignments for one or more remote communication devices; and
transmitting at least some qudits of the series of multiple qudits to at least some of the one or more remote communication devices;
wherein measurement of at least one qudit received at a first device of the one or more remote communication devices results in collapse of the respective superposition of the multiple states encoded in the at least one qudit into a respective one of the multiple states, with the collapsed states of the at least one qudit measured at the first device representing an assignment to a distinct communication channel, from the multiple communication channels, through which the first device is configured to transmit and receive data.

13. The method of claim 12, wherein generating the series of multiple qudits comprises:
generating a quantum data record for each of the one or more communication devices, wherein the quantum data record stores entangled quantum information proportional to a sum of channel assignment permutation states for the one or more remote communication devices.

14. The method of claim 12, wherein generating the series of multiple qudits comprises:
preparing a superposition of states, wherein preparation of the superposition of the states by the scheduler with knowledge of an assigned channel measurement at the first device gives no information about measurement results at a second communication device, from the one or more remote communication devices, that is different from the first device or the scheduler.

15. A secure communication system comprising:
one or more remote communication devices configured to establish communication links using multiple communication channels available at the communication system; and
a scheduler node configured to communicate with the one or more plurality of remote communication devices, the scheduler node comprising a processor-based device and quantum processing and communication circuitry, wherein the scheduler is configured to:
generate a series of multiple quantum bits (qubits), each qubit of the series of multiple qubits encoding information representing a superposition of multiple states relating to channel assignments for at least some of the one or more of the remote communication devices; and
transmit at least some qubits of the series of multiple qubits to at least some of the one or more remote communication devices;
wherein measurement of the at least some qubits at a first device of the one or more remote communication devices results in collapse of the respective superposition of the multiple states encoded in each qubit of the at least some qubits into a respective one of the multiple states, with the collapsed states of the transmitted at least some qubits measured at the first device representing an assignment to a distinct communication channel, from the multiple communication channels, through which the first device is configured to transmit and receive data.

16. The system of claim 15, wherein the scheduler node configured to generate the series of multiple qubits is configured to:
generate the series of multiple qubits encoding entangled information representing the superposition of multiple states, with the entangled information allowing assignment of a second communication channel assignment, distinct from the first channel assignment, through which a second device of the one or more remote communication devices is configured to transmit and receive data.

17. The system of claim 15, wherein the distinct communication channel links the first device to one or more of: a base station to allow the first device and the base station to communicate through the assigned distinct communication channel, and at least one other device from the one or communication devices that is assigned the distinct communication channel assigned to the communication device to allow the communication device and the at least one other device to communicate through the assigned distinct communication channel upon measurement of the entangled qubits by the communication device.

18. The system of claim 15, wherein the scheduler node configured to generate the series of multiple qubits is configured to:
generate one or more groups of multiple qubits;
select from each group of multiple qubits a subset of qubits, wherein a combination of selected subsets from the each group includes entangled quantum information about channel assignments for an associated at least one of the remote communication devices.

19. The system of claim 18, wherein the scheduler node is further configured to:
transmit to each of the at least some of the remote communication devices a corresponding one of combinations of qubits subsets selected from the each group of multiple qubits;
wherein a first combination of selected subsets transmitted to a first remote communication device associated with the first combination is different from a second combination of selected subsets transmitted to a second remote communication device associated with the second combination.

20. The system of claim 15, wherein the scheduler node configured to transmit the at least some qubits is configured to:
transmit the at least some qubits, encoded using photons, through an optical-type quantum channel.

21. A method for secure communication comprising:
receiving at a communication device, in a communication system with multiple communication channels and comprising one or more communication devices, at least a portion of a series of multiple quantum bits (qubits) generated at a remote scheduler node, each qubit of the series of multiple qubits encoding information representing a superposition of multiple states relating to channel assignments for at least some of the one or more of the remote communication devices; and
measuring at the communication device the received at least the portion of the series of qubits to cause a collapse of the respective superposition of the multiple states encoded in at least the portion of the series of qubit into a respective one of the multiple states, the collapsed states of the measured series of qubits representing a distinct communication channel assignment through which the communication device is configured to transmit and receive data.

22. The method of claim 21, wherein the distinct communication channel links the communication device to one or more of: a base station to allow the first device and the base station to communicate through the assigned distinct communication channel, and at least one other device from the one or communication devices that is assigned the distinct communication channel assigned to the communication device to allow the communication device and the at least one other device to communicate through the assigned distinct communication channel upon measurement of the entangled qubits by the communication device.

23. The method of claim 21, wherein receiving the at least a portion of a series of multiple qubits comprises receiving the at least the portion of the series of multiple qubits, encoded using photons, through an optical-type quantum channel.
